(19) United States
(12) Patent Application Publication
(10) Pub. No.: US 2004/0205129 A1
(43) Pub. Date: Oct. 14, 2004

(54) Collaboration framework

(75) Inventors: H. Bruce Bongiorni, Ann Arbor, MI (US); Mark H. Spicknall, Brighton, MI (US); Matthew D.T. Williamson, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Business Performance Group, LLC

(21) Appl. No.: 10/790,331

(22) Filed: Mar. 1, 2004

Related U.S. Application Data
(63) Continuation of application No. PCT/US03/39572, filed on Dec. 12, 2003.
(60) Provisional application No. 60/433,531, filed on Dec. 13, 2002.
(60) Provisional application No. 60/461,942, filed on Apr. 9, 2003.
(60) Provisional application No. 60/515,302, filed on Oct. 28, 2003.

(51) Int. Cl. G06F 15/16

(52) U.S. Cl. 709/204

(57) ABSTRACT

The collaboration framework is a facility for entities, such as service providers and tools, to work jointly in the intellectual endeavor of finding solutions to engineering problems. The collaboration framework incorporates protocols and means for expansion and interfacing with Web services as well as discoverable, reusable work flows for solving engineering problems. Other problems for which the collaboration framework can be used include military operations, emergency responses, such as responses to an earthquake, fire, terrorism, or other disaster.

### CROSS-REFERENCES TO RELATED APPLICATIONS

This application is a continuation of PCT/US03/39572, designating the United States, filed Dec. 13, 2003. This application further claims the benefit of U.S. Provisional Application No. 60/433,531, filed Dec. 13, 2002, which is incorporated herein by reference; U.S. Provisional Application No. 60/461,942, filed Apr. 9, 2003, which is incorporated herein by reference; and U.S. Provisional Application No. 60/515,302, filed Oct. 28, 2003, which is incorporated herein by reference.

### FIELD OF THE INVENTION

The present invention relates generally to a collaboration framework, and more particularly, to a facility for collaboration among entities incorporating protocols and means for expansion and interfacing with Web services as well as a reusable work flow.

### BACKGROUND OF THE INVENTION

Engineering projects of any size depend on the collaboration of diverse groups with particular expertise in various areas. Large engineering projects may require government laboratories, academic institutions, businesses, and even military departments to work together in the intellectual endeavor of conceiving, designing, engineering, testing, and operating resultant systems or products. Over time, participants in these engineering projects may change, causing the knowledge of how decisions were made to conceive, design, engineer, test, and operate, to diminish or vanish. This is especially perilous in cases where effective military operations and national defense are at stake. A system 100 shown at FIG. 1 illustrates these and other problems in greater detail.

The system 100 describes a community of experts for designing a torpedo 102. The torpedo 102 is a thin cylindrical self-propelled underwater projectile, which is used as a weapon for destroying ships by rupturing their hulls below the water line. Among the experts that help to design the torpedo 102 are government laboratories 104, which are places equipped for experimental study in torpedo science or for testing and analysis of produced torpedoes. Academic institutions 106, which are established organizations or corporations, such as colleges or universities, especially those of a public character, also contribute to the design of the torpedo 102. Another set of experts for designing the torpedo 102 come from military departments 108, which include armed forces, such as ground forces, air forces, and naval forces. Businesses 110, which are commercial and oftentimes industrial enterprises, contribute the bulk of the engineering effort toward the design of the torpedo 102.

One of the problems with the system 100 is that there is a lack of a facility to integrate the steps of conceiving, designing, engineering, testing, and operating by the government laboratories 104, academic institutions 106, military departments 108, and businesses 110. Typically, a complex engineering design or problem, such as the torpedo 102, requires a multitude of solutions formed from decisions made by multiple experts in an array of disciplines, each with its own set of specific tools, such as software. There is no facility to allow multiple experts with their multiple tools to cooperate and negotiate solutions to a complex engineering design or problem, causing some of them to acquire redundant tools and expend resources to maintain them. Additionally, because requirements for a complex engineering design or problem are not static but can be changed (especially in the early stage of a project), the lack of a facility to integrate multiple experts can hinder the timely communication of changes.

A further problem is that old tools, such as legacy software applications, remain quite valuable for solving certain complex engineering designs and problems. The design of torpedoes is exemplary. There are not many software applications in the world that can help experts design torpedoes. However, some of these legal software applications are older and have been war tested and some are new, incorporating better understanding of torpedo science. The problem is that there is a lack of a facility to integrate these legacy software applications with each other.

The most pernicious problem of all is that for many complex engineering designs and problems, the number of original experts that were involved in the decision-making process to create or solve complex engineering designs or problems, such as the torpedo 102, is getting smaller. The knowledge base and experience base has diminished or is no longer around. Students are no longer graduating in certain academic disciplines, such as torpedo design. The system 100 lacks a facility to capture knowledge and the decision-making process in the design of the torpedo 102 so that those decisions can be studied in the future as a starting point for new projects or to solve an existing problem. It is hard to leverage knowledge unless that knowledge is captured so that it can be accessed again.

Thus, there is a need for better methods and systems for allowing service providers to cooperate and capture knowledge generated by these service providers and their tools for future use while avoiding or reducing the foregoing and other problems associated with existing systems.

### SUMMARY OF THE INVENTION

In accordance with this invention, a system and method for executing a collaborative framework is provided. The system form of the invention comprises a networked system, which comprises a set of Web services. Each Web service represents a member selected from a group consisting of a human service provider and a piece of software. The networked system further comprises a collaboration framework for allowing the set of Web services to work jointly together to solve an engineering problem. The collaboration framework includes a universal description discovery and integration framework that has information pertaining to verification, validation, and accreditation of each Web service in the set of Web services.

In accordance with further aspects of this invention, a further system form of the invention comprises a system for allowing Web services to collaborate. The system comprises a set of Web services. Each Web service is selected from a group consisting of a first service representing a piece of software that provides engineering analysis, a second service representing a human that provides engineering analysis, and a composed service. The system further comprises a service registry for allowing the set of Web services to be registered, the service registry being capable of allowing the registered Web services to be discovered.

In accordance with further aspects of this invention, another system form of the invention comprises, in a computing system, a set of collaborative software agents. These collaborative software agents comprise a set of functional agents for coordinating Web services within an engineering discipline and a set of community agents for coordinating functional agents across engineering disciplines. The set of community agents includes an arrangement configuration design and analysis community agent. The set of community agents further includes a requirements definition and management community agent. The set of community agents also comprises a multi-disciplinary analysis and optimization community agent. The set of community agents yet further comprises a distributed computing community agent. The set of community agents as yet further comprises a workflow management community agent. The set of community agents additionally comprises an application and model integration community agent.

In accordance with further aspects of this invention, the method form of the invention is implementable in a computer system. The method for executing a collaboration framework comprises registering Web services by the service provider with the collaboration framework. The method also comprises issuing solution requirements by a project sponsor Web service. The method further comprises forming of a project team by a chief engineer Web service. The method yet further comprises capturing a workflow as the project team designs a solution to satisfy the solution requirements.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating a conventional system for designing a torpedo;

FIG. 2A is a block diagram illustrating an exemplary collaboration framework for facilitating cooperation among service providers, such as government laboratories, academic institutions, military departments, and businesses;

FIG. 2B is a block diagram illustrating the exemplary collaboration framework, which includes a service registry, community agents, functional agents, project data manager, workflow manager, messaging manager, and various services;

FIG. 2C is a block diagram illustrating an exemplary service registry, according to one embodiment of the present invention;

FIG. 2D is a structured diagram illustrating a credibility schema for a service registry for verification, validation, and accreditation purposes, according to one embodiment of the present invention;

FIG. 2E is a structured diagram illustrating an accreditation schema for the service registry for verification, validation, and accreditation purposes, according to one embodiment of the present invention;

FIG. 2F is a structured diagram illustrating a capability schema for verification, validation, and accreditation purposes, according to one embodiment of the present invention;

FIG. 2G is a block diagram illustrating a number of community agents, according to one embodiment of the present invention; and

FIGS. 3A-3I are method diagrams illustrating an exemplary method formed in accordance with this invention for executing a collaboration framework, according to one embodiment of the present invention.

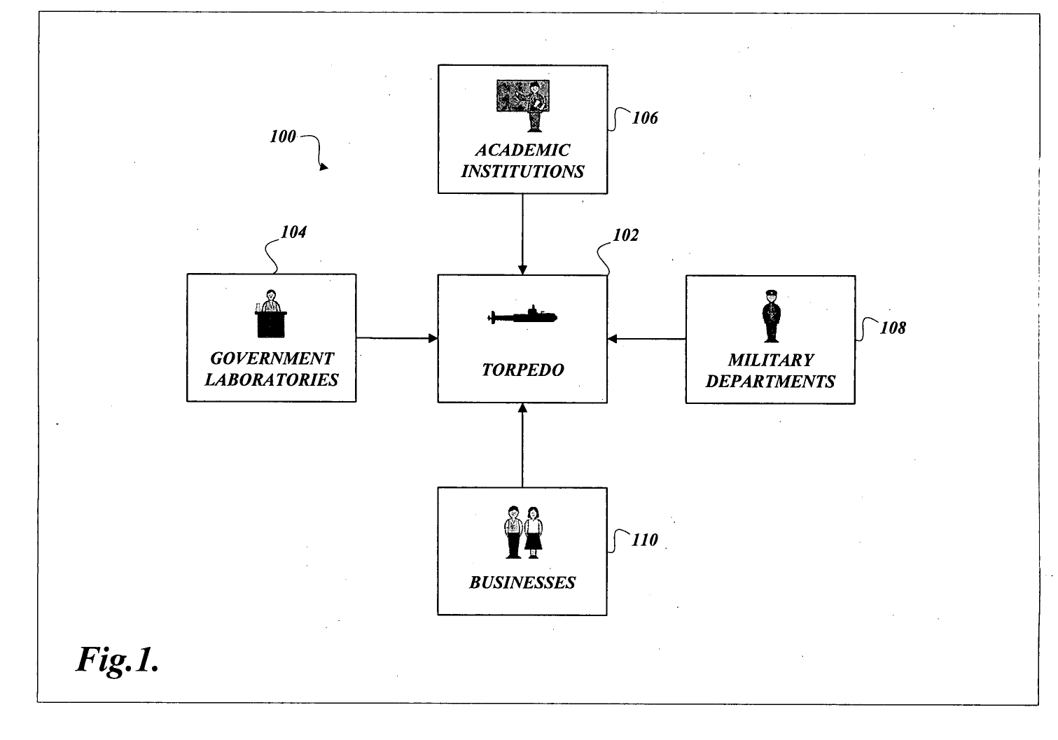

### DETAILED DESCRIPTION OF THE PREFERRED EMBODIMENT

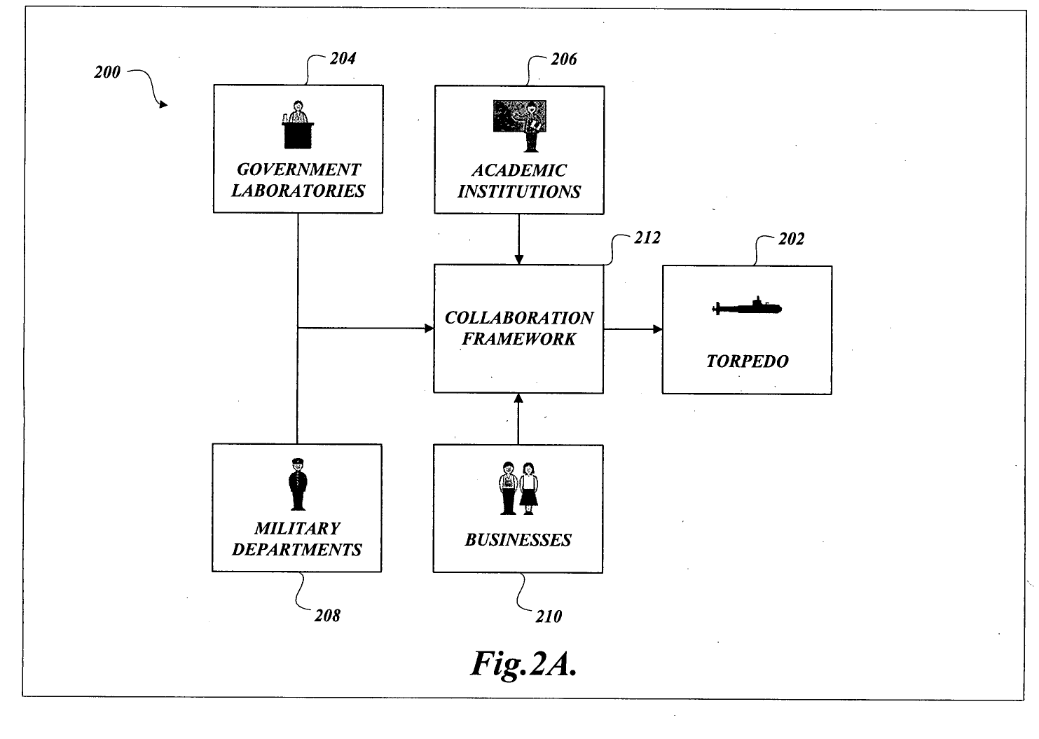

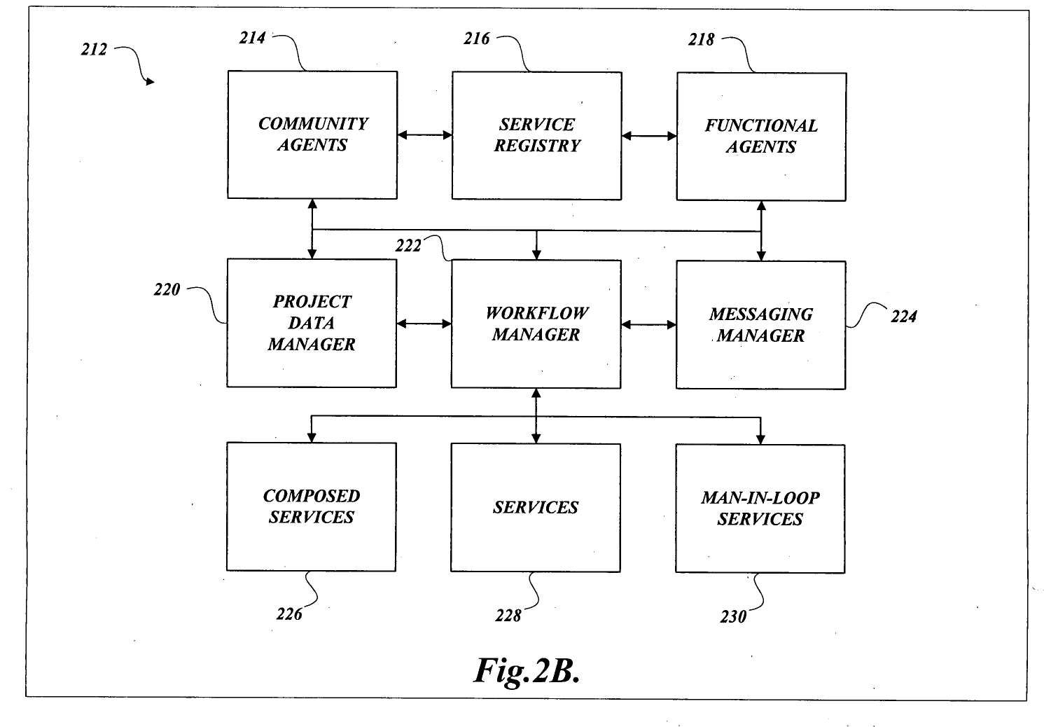

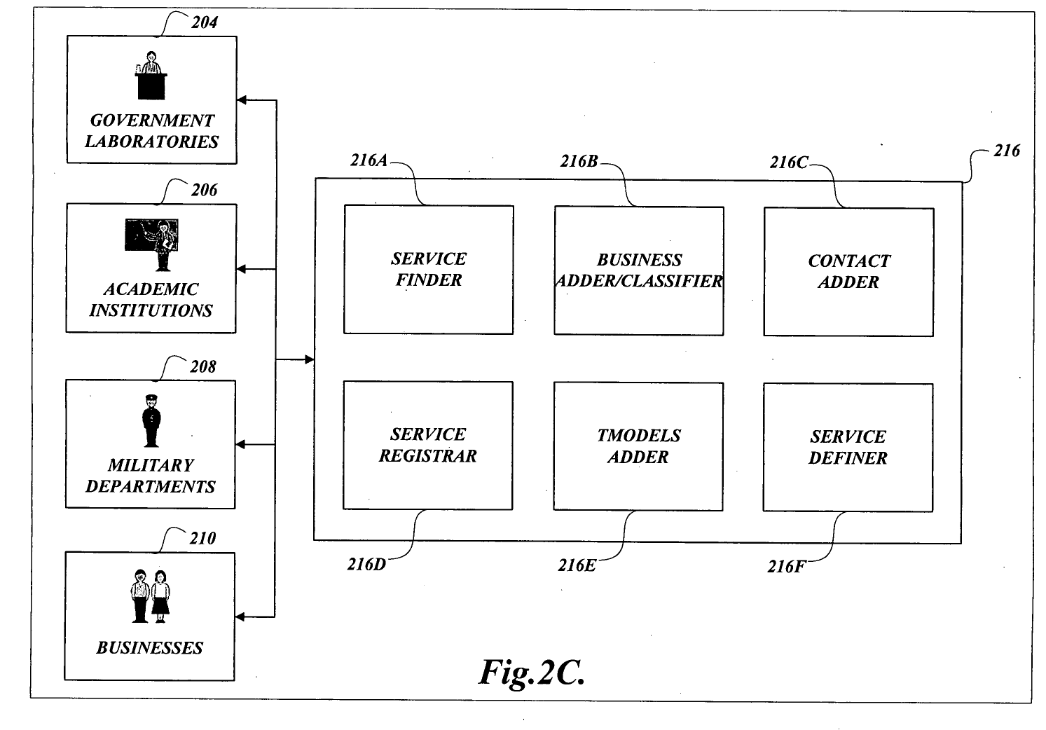

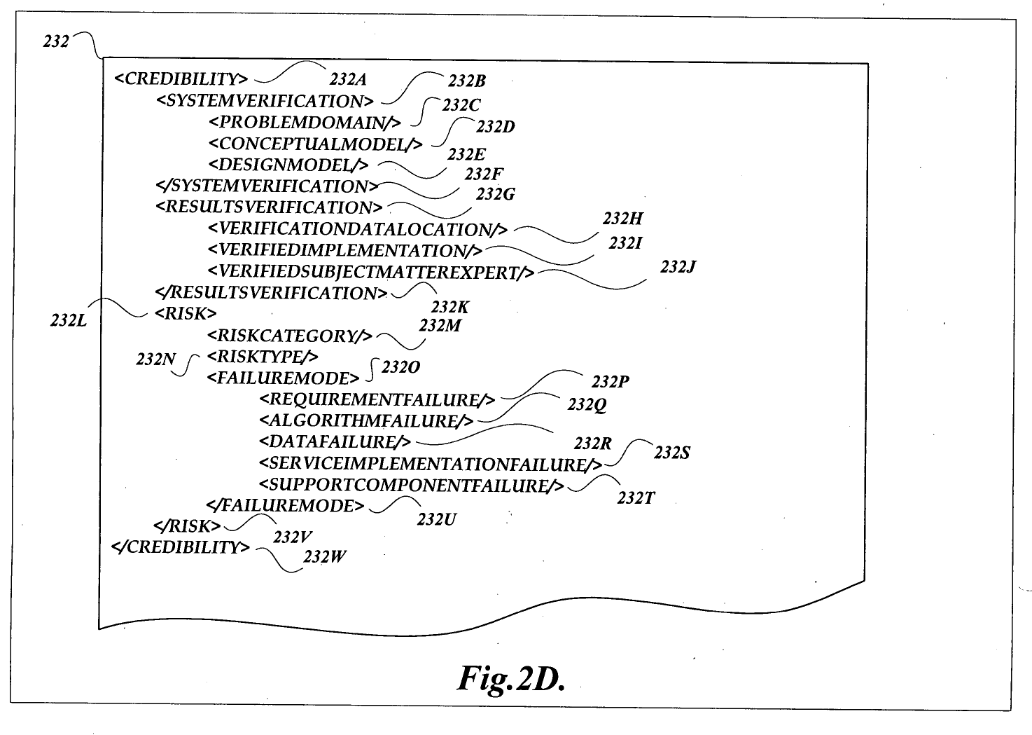

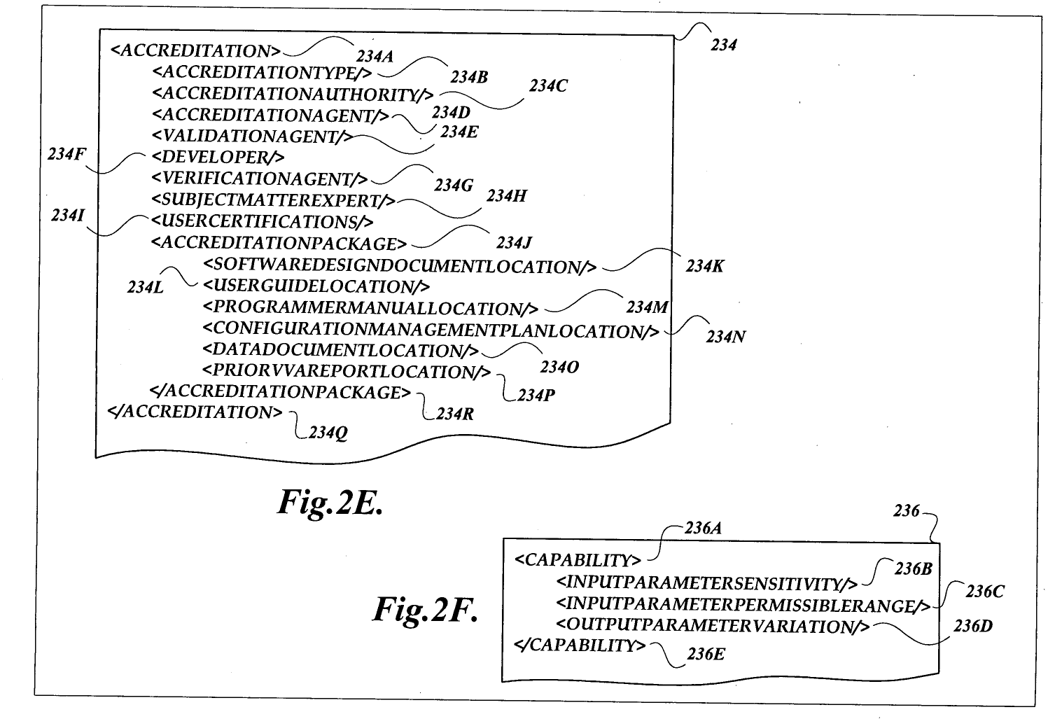

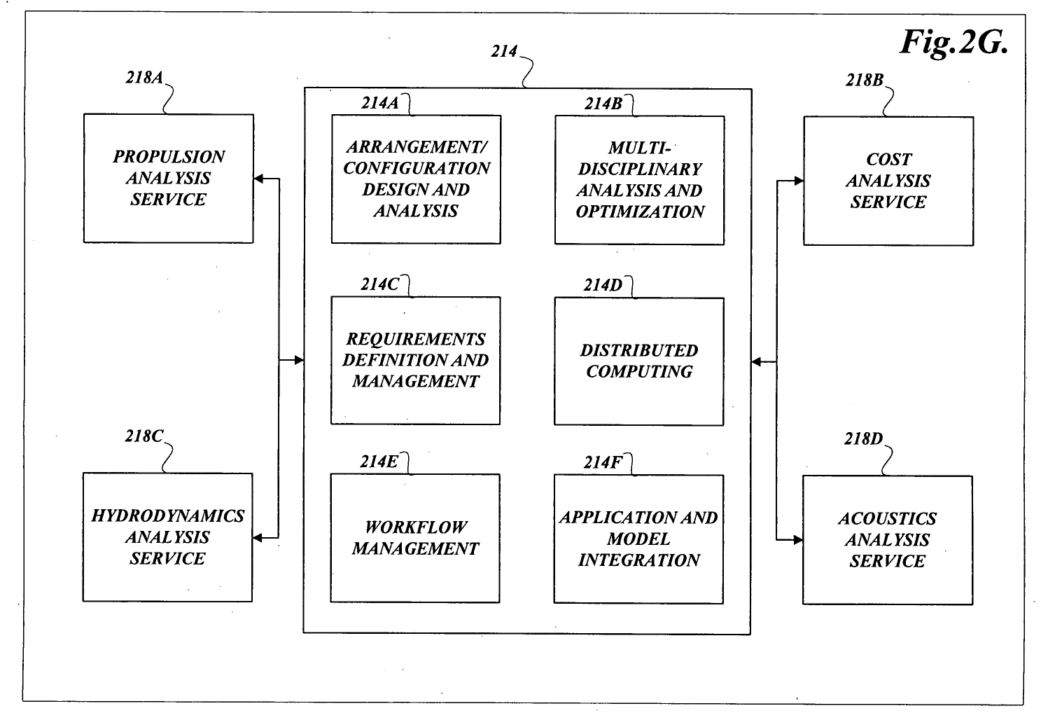

Various embodiments of the invention provide a collaboration framework, which integrates service providers and their tools, allowing cooperation and negotiation of solutions to engineering problems. The collaboration framework is a facility for entities, such as service providers and tools, to work jointly in the intellectual endeavor for finding solutions to engineering problems. The collaboration framework incorporates protocols and means for expansion and interfacing with Web services as well as discoverable, reusable work flows for solving engineering problems. Other problems for which the collaboration framework can be used include emergency responses, such as responses to an earthquake or a fire. An exemplary collaboration framework 212 is illustrated at FIG. 2A.

A system 200 includes the collaboration framework 212 for designing a torpedo 202. The collaboration framework 212 enables a community of service providers and their tools to share capabilities and knowledge. The collaboration framework 212 facilitates the sharing of capabilities and knowledge based on a computing infrastructure of Web services that allows service providers and their tools to come together as a community to conceive, design, engineer, test, and operate resultant systems and products, such as the torpedo 202.

Service providers include government laboratories 204, which are places equipped for experimental study in a science of a particular discipline or for testing and analysis. Academic institutions 206 are another set of service providers, namely established organizations or corporations, such as colleges or universities, especially those of a public character. Military departments 208, which include all armed forces, such as ground forces, air forces, and naval forces, can also be service providers. Businesses 210 comprise the remaining set of experts, which are commercial and oftentimes industrial enterprises providing the bulk of the labor and various technical expertise to design the torpedo 202. The torpedo 202 is basically a submarine mine, comprising a thin, cylindrical, self-propelled underwater projectile weapon for destroying ships by rupturing their hulls below the water line.

The collaboration framework 212 enables cooperation among service providers 204-210 and enhances existing relationships among service providers 204-210 as well as aiding in the formation of new relationships to help better design the torpedo 202. While the collaboration framework 212 integrates various Web services, such as analysis services, the collaboration framework 212 can include man-in-loop services, each being a service provided by a human service provider who interfaces with the collaboration framework 212 through a Web service (a man-in-loop service). To allow knowledge to be retained and be mined for future use, the collaboration framework 212 provides mechanisms to learn, retain, and reuse experiences and knowledge generated by the cooperation of service providers 204-210 in designing the torpedo 202.

FIG. 2B illustrates the collaboration framework 212 for integrating service providers 204-210. A service registry 216 allows Web services to be registered and discoverable by listing the available services for participating in a project. The service registry 216 is preferably implemented as an enhanced universal description, discovery, and integration (UDDI) framework. The service registry 216 provides a way to register and discover Web services by providing business contact information; organizing Web services into categories; and providing detailed technical information about individual Web services. The service registry 216 allows service providers 204-210 to register their services and discover needed services to solve tasks associated with the project. The service registry 216 provides access to pieces of information to make decisions regarding the service that is suitable for a particular task within the project. These pieces of information include business entities, points of contact for technical information, documentation about the service, and data regarding how a service provider can access a desired service. Services, such as services 228, composed services 226, and a man-in-loop services 230, may register themselves with the service registry 216 to advertise their availability for performing a particular task. Communications between the collaboration framework 212 and the man-in-loop services 230 preferably occur through e-mail, but other suitable forms of communications may be used. Services 228 and man-in-loop services 230 can be put together to form composed services 226. Services 226-230 comprise current applications, legacy software, or services provided by a human being who interfaces with the collaboration framework through a Web service.

Functional agents 218 interact, coordinate, and execute services 226-230 within a particular technical discipline, such as hydrodynamics analysis, for the design of the torpedo 202. In contrast, the community agents 214 provide interaction, coordination, and execution of services 226-230 across technical disciplines. Both the functional agents 218 and the community agents 214 use the service registry 216 to gain access to services 226-230.

Whereas the service registry 216 provides a list of available services to accomplish a task or a project, a project data manager 220 can query the service registry 216 to access Web Service Description Language (WSDL) files associated with the requested services by the service providers 204-210 in a project. These files (not shown) specify services in the form of application programming interfaces. The project data manager 220 can also inspect the files and create a database for the project. A work flow manager 222 causes services 226-230 to cooperate in communication with the project data manager 220. The work flow manager 222 captures and stores decisions, knowledge, and experiences as service providers 204-210 in a project to proceed with the development process. This ability to capture the workflow allows the collaboration framework 212 to indefinitely retain information for future analysis and operation, even if the original service providers 204-210 depart. The messaging manager 224 allows services to be wrapped in a programmatical manner so that they can connect to the collaboration framework 212. Services can be wrapped using a number of suitable protocols. One suitable protocol includes a customizable, tag-based protocol, such as Simple Object Access Protocol (SOAP).

FIG. 2C illustrates the service registry 216 in greater detail. Service providers 204-210 communicate with the service registry 216 to register their services through the service registrar 216D and find services of interest by the service finder 216A. Adding business information to the service registry 216 allows other service providers 204-210 to find the business based on what the business does and the types of services that the business provides. To add a business, a business adder/classifier 216B is used. The business adder/classifier 216B queries for information, such as the name of the business and a brief description of the business. The business adder/classifier 216B also allows a service provider to classify the business by the location of the business, as well as by what the business does. A contact adder 216C allows a service provider to provide various contacts so that others may license the registered service, obtain support for the service, or contact the service provider regarding other business-related questions. The contact adder 216C queries for the name of the contact, as well as for other pieces of information, such as an e-mail address, phone number, and an address of the contact.

When a service provider has been added and classified by the business adder/classifier 216B, a tModels adder 216E is used to add tModels. tModels are the “technical model”, which is a UDDI element used to point to external technical specifications. tModels are referenced by the WSDL document as a namespace in order to provide the necessary meaning to the tags used to describe the message components (e.g., variable types). As such, tModels define the types used by the registered service, as well as the messages and operations for the registered service.

Services 226-230 in the collaboration framework 212 have three things in common: (1) services 226-230 expose useful functionality to service providers 204-210 via a set of interfaces through a standard protocol, such as SOAP; (2) services 226-230 describe a set of interfaces in a document using WSDL, which is written in enough detail to allow users to build applications to talk to services 226-230; and (3) services 226-230 are registered so that potential users can find services 226-230 easily using UDDI. A WSDL file is a document that describes a set of messages written in a particular protocol and how these messages are to be exchanged. In other words, a WSDL file describes a service's interface in terms of messages the service can generate and accept. In addition to describing message content, WSDL files define where the service is available and what communications protocol can be used to talk to the service. A WSDL file is added to the service registry 216 via the tModels adder 216E. (If a tModel document and/or a WSDL file is available, then the locations are added as part of the registration process. A WSDL file can be either manually written or with an automated authoring tool. Using the authoring tool, similarly, a verification, validation, and accreditation tModel file, which is described in greater detail below, is encoded using the tags defined by a verification, validation, and accreditation schema.) The tModels adder 216E allows the service provider to provide the name of the service and its description. Additionally, the location of the WSDL file, such as a uniform resource locator (URL), is provided by the service provider.

Once the WSDL file is added, the service provider declares that the service exists via a service definer 216F. The service definer 216F allows the service provider to bind the registered service with the tModel or the WSDL file added via the tModels adder 216E. (If there is no WSDL file, it is preferred that there is at least a verification, validation, and accreditation tModel file.)

Various embodiments of the present invention enhance the service registry 216 to provide additional data structures beyond the conventional UDDI framework to support validation, verification, and accreditation of engineering services; quality and application contacts information, such as accuracy and resolution; user qualifications, such as business permissions and expertise requirements; and ownership and responsibility. (tModel files need not exist in various embodiments of the present invention. If there is not a tModel file, verification, validation, and accreditation information is registered into the UDDI framework for engineering services.) To determine whether a Web service should be used in a given situation, various embodiments of the present invention allow the credibility of the Web service to be established by evaluating the service's fitness for an intended use. Various services registered with the service registry 216 are preferably infused with verification, validation, and accreditation information to allow a service provider or a service to gather, evaluate, and determine a registered service's capabilities, limitations, and performance. Based on this determination, a decision to invoke a registered service can be based on the Web service's capabilities, correctness, accuracy, and usability for an intended task or project. Credibility of a Web Service preferably depends on the Web service's capability relative to the capabilities needed for the specified use. Credibility of the Web service also preferably depends on the Web service's accuracy relative to the accuracy necessary for its intended use. The decision of whether a Web service can be used preferably depends on the inherent characteristics of the service, on how the Web service would be used, and on the significance of any decision that may be reached using the Web service's outputs. Accreditation of a service is an official certification that the service and its data are fit for use in a specified application.

FIG. 2D illustrates a customizable, tag-based credibility schema 232, which contains information regarding the verification, validation, and accreditation of services registered in the service registry 216. One suitable language to implement the credibility schema 232 includes extensible markup language (XML), but others can be used. The schema 232 includes a root tag <CREDIBILITY> 232A and its companion ending tag </CREDIBILITY> 232W. Enclosed between tags 232A, 232W is tag <SYSTEMVERIFICATION> 232B and its companion ending tag </SYSTEMVERIFICATION> 232F. Tags 232B, 232F contain information for determining that the service accurately represents the finctional design and has traceability to the conceptual model and system requirements. Between tags 232B, 232F is a tag <PROBLEMDOMAIN/> 232C that contains information pertaining to a subject or area of interest of a specified problem. This typically encompasses a broad area because it includes the total area from which information can be obtained about the subject of the application. Requirements associated with the problem domain are normally concerned with the nature of the problem and the overall level of representation needed to produce a result. Between tags 232B, 232F is tag <CONCEPTUALMODEL/> 232D, which contains information regarding assumptions, algorithms, and architecture that relate the elements of one service to another service. Additionally, tag 232D describes the data that is used by, embedded in, or produced by the service. Between tags 232B, 232F is a tag <DESIGNMODEL/> 232E, which contains information regarding functional design verification based on the service specification. Tag 232E preferably defines the hardware, software, and personnel that comprise the service. Enclosed between tags 232A, 232W is tag <RESULTSVERIFICATION> 232G and its companion ending tag </RESULTSVERIFICATION> 232K. Tags 232G, 232K contain information regarding validation from a formal test process that compares the responses of the service with known or expected behavior from the subject the service represents so as to ascertain that the service's responses are sufficiently accurate for the intended users. Preferably, the results verification and validation information is derived from a comparison of the results of the Web service to some authoritative reference data that defines what the expected results should be. Between tags 232G, 232K is tag <VERIFICATIONDATALOCATION/> 232H, which contains information regarding the network or relative path address of representative input data for use of the Web service. The data is validated for its correctness and the use of the provided data should result in valid and accepted results. Verification and validation can be conducted on different sets of data, hence the need for multiple locations. Different data sets may also be obtained or required at different times in the use of the service. Contained between tags 232G, 232K is tag <VERIFIEDIMPLEMENTATION/> 232I. Tag 232I contains information pertaining to the network or relative path address for a reference implementation of the service. This may be an instance of the same service hosted by the service owner or a service that can be used to compare the results with those of another service. Different verification and validation tasks and methods may be required for different data sets and different services, and using other techniques and tools may be required. Between tags 232G, 232K is tag <VERIFIEDSUBJECTMATTEREXPERT/> 232J. Tag 232J contains information regarding people performing data validation and verification activities, which frequently require different qualifications for exemplary expertise associated with the individual data sets.

Between tags 232A, 232W is tag <RISK> 232L and its companion ending tag </RISK> 232V. Tags 232L, 232V represent information pertaining to the primary risk in a Web service in that it will produce an incorrect result or will fail. (Failure of a service is defined as its returning wrong results. Another interpretation of a service failure would be if it were inaccessible or unavailable. This latter failure is in physical performance and not necessarily related to the credibility of the service.) Between tags 232L, 232V is tag <RISKCATEGORY/> 232M, which defines (in problem-specific terms) a number of category failures. Five exemplary risk categories described by tag 232M include results that cannot be corrected or allowed for in an engineering decision; results that require significant intervention in making the engineering decisions; results that can be accounted for in the engineering system; results in which errors are easily accounted for in the engineering decisions; and results in which errors have no impact on the engineering decision. Between tags 232L, 232V is tag <RISKTYPE/> 232N for describing the type of risk associated with the service. Enclosed between tags 232L, 232V is tag <FAILUREMODE> 232O and its companion ending tag </FAILUREMODE> 232U. Tags 2320, 232U represent a failure mode where a failure can occur only when the Web service is being used for its intended purposes (an incorrect result occurring at any other time, such as during testing of the service, would not be defined as a failure). Between tags 2320, 232U is tag <REQUIREMENTFAILURE/>232P, which contains information regarding misunderstandings regarding requirements identified during the requirements verification for conceptual model validation. During a new service development, requirement tracing throughout the development process can help identify related problems before they become failures. When a legacy service is involved, the service provider compares the requirements of a current application with the capability of the selected legacy service to determine whether there are any inconsistencies or inadequacies. Contained between tags 2320, 232U is tag <ALGORITHMFAILURE/> 232Q, which represents algorithms used to generate specific results (e.g., attrition algorithms, path generators, and so on) and the associated data (e.g., hard-wired data, input instance data, and so on) that preferably are accurate and of an appropriate level of fidelity. Tag 232Q includes algorithm failures that involve a mismatch between a statistical distribution for sampling in the service. Between tags 232O, 232U is tag <DATAFAILURE/> 232R, which contains similar information as tag 232Q. Contained between tags 232O, 232U is tag <SERVICEIMPLEMENTATIONFAILURE/> 232S, which contains information identified by the developer of the service regarding which system components or algorithms may cause the service to fail to meet a requirement during execution. Tags 232O, 232U include tag <SUPPORTCOMPONENTFAILURE/> 232T, which contains information regarding factors that may contribute directly or indirectly to the service's inability to satisfy a requirement due to a failure in the support components, such as man-in-loop servers, networks, interface devices, post-processors, analysts, operators, and so on.

FIG. 2E illustrates an accreditation schema 234, which is used to provide accreditation information to service providers and services regarding a particular registered service. This accreditation schema 234 includes a root tag <ACCREDITATION> 234A and its companion ending tag </ACCREDITATION> 234Q. Between tags 234A, 234Q is tag <ACCREDITATIONTYPE/> 234B, which describes the type of accreditation that the service has received. Various types of accreditation are possible, such as “full” accreditation, which informs that the service can be used as is; “limited” accreditation, which informs that the service's use should be constrained to minimize risks; “modification needed” accreditation, which informs that corrections ought to be made to reduce risks even though such corrections may increase costs and cost delays; “additional information is needed” accreditation, which informs that more information is needed in order to understand the risks involved so as to instill confidence in the service's fitness before making a decision to use; and “no accreditation” accreditation, which informs that the risks involving using the service and the costs involving fixing the service are both too great. Between tags 234A, 234Q is tag <ACCREDITATIONAUTHORITY/> 234C, which describes the accreditation authority for the service. Tag 234C includes information such as the program reference and program proponents, such as the program manager (a term used to define a role responsible for planning and managing resources for simulation development or modification, directing the overall simulation effort, and overseeing configuration management and maintenance of the simulation) and deputy program manager. Between tags 234A, 234Q is tag <ACCREDITATIONAGENT/> 234D, which contains information regarding a role responsible for conducting the accreditation assessment. The accreditation agent provides guidance to the verification and validation agent to ensure that all the necessary evidence regarding simulation fitness for use is obtained, collects and assesses the evidence, and provides the results to the service provider, whose role is endowed with the responsibility of making the accreditation decision. Between tags 234A, 234Q is tag <VALIDATIONAGENT/> 234E, which describes a verification and validation agent used for providing evidence of the service's fitness for the intended use by ensuring that all of the verification and validation tasks are properly carried out. Between tags 234A, 234Q is tag <DEVELOPER/> 234F, which includes information pertaining to a role responsible for actually constructing and modifying the simulation represented by the service, preparing the data for use in the simulation, and providing technical expertise regarding simulation capabilities as needed by other roles. Contained between tags 234A, 234Q is tag <VERIFICATIONAGENT/> 234G, which includes information regarding a role responsible for providing evidence of a simulation's fitness for the intended use by ensuring that all of the verification and validation tasks are properly carried out.

Contained between tags 234A, 234Q is tag <SUBJECTMATTEREXPERT/> 234H, which describes an auxiliary role that contributes to the verification, validation, and accreditation effort. A subject matter expert is an individual who is recognized as an authority in a specific area. Expert opinions may be needed in a variety of different areas in a given application, ranging from aspects of the problem domain being simulated to the data and computing technology needed by the simulation. The subject matter expert can be called upon to help in a variety of ways from helping the service provider in establishing requirements and acceptability criteria to participating in validation and accreditation assessment activities. One subject matter expert described by tag 234H is a domain expert. Once Web service development begins, domain experts are needed to create an authoritative description of the Web service context in the conceptual model. Once Web service objectives have been established and stated in a set of requirements for the Web service, development of the Web service conceptual model may begin. Sometimes the conceptual model development will occur in parallel with the development of other requirements. Normally, the first step in conceptual model development is for the Web service developer to collect authoritative information about the intended application domain that forms the Web service context. Another subject matter expert includes Web service development experts. Web service development experts have computer hardware or software expertise to successfully develop Web services. These experts enable a Web service developer to use appropriate software development tools and techniques, to make good decisions about computer hardware and operating systems, to select an appropriate architecture, to choose appropriate software languages, to produce appropriate documentation efficiently, to employ appropriate Web service and software development paradigms, and so on. Another subject matter expert includes Web service application experts.

Between tags 234A, 234Q is tag <USERCERTIFICATIONS/> 234I. Tag 234I contains information pertaining to an organization, group, or person responsible for the overall Web service. The service provider needs to solve a problem or make a decision and wants to use a Web service to do so. The service provider defines the requirements, establishes the criteria by which Web service fitness will be assessed, determines what method to use, makes the accreditation decision, and ultimately accepts the results of the Web service. There are three certification levels identified by tag 234I, which include domain certification, service certification, and application certification. Between tags 234A, 234Q is tag <ACCREDITATIONPACKAGE> 234J and its companion ending tag </ACCREDITATIONPACKAGE> 234R. Between tags 234J, 234R is tag <SOFTWAREDESIGNDOCUMENTLOCATION/> 234K, which is indicative of the location of the software design document; tag <USERGUIDELOCATION/> 234L, which is indicative of the location of the user guide; tag <PROGRAMMERMANUALLOCATION/> 234M, which is indicative of the location of the programmer manual; tag <CONFIGURATIONMANAGEMENTPLANLOCATION/> 234N, which is indicative of the location of the configuration management plan; tag <DATADOCUMENTLOCATION> 2340, which is indicative of the location of the data document; and tag <PRIORVVAREPORTLOCATION/> 234P, which is indicative of the location of the prior verification, validation, and accreditation report.

FIG. 2F illustrates a capability schema 236, which is used by the verification, validation, and accreditation process. The schema 236 has a route tag <CAPABILITY> 236A and its companion ending tag </CAPABILITY> 236E, which contains information indicating the capability of the Web service. Between tags 236A, 236E is tag <INPUTPARAMETERSENSITIVITY/> 236B, which contains verification information regarding the changing of a Web service's input and initial condition parameters to determine the effect and the output. Sensitivity analysis provides testing without needing extensive details of the Web service's algorithms. Only input parameters or initial conditions are modified. Each input parameter can be tested over its valid range; preferably, over its boundary conditions (which includes minimum, maximum, and worst case conditions). Tags 236A, 236E, include tag <INPUTPARAMETERPERMISSIBLERANGE/> 236C, which indicates the range of the input parameter for the Web service. Between tags 236A, 236E is tag <OUTPUTPARAMETERVARIATIONS/> 236D, which indicates the range of the output parameter.

FIG. 2G illustrates, in greater detail, the community agents 214 and examples of the functional agents 218. Instances of the functional agents include a propulsion analysis service 218A, a cost analysis service 218B, a hydrodynamics analysis service 218C, and acoustics analysis service 218D. Each of services 218A-218D provides output values from a particular discipline, such as propulsion, cost, hydrodynamics and acoustics, in designing the torpedo 202. Community agents 214A-214F integrate functional agents, such as services 218A-218D, together to complete a task or a project. Arrangement/configuration design and analysis community agent 214A supports the definition and analysis of a system or product arrangement and physical configuration. The community agent 214A allocates space and component positions and monitors geometric parameters and component relationships. Additionally, the community agent 214A compares geometric parameters to requirements and performance restraints and reports constraints/requirement violations to a requirements definition and management community agent 214C. A multi-disciplinary analysis and optimization community agent 214B supports total functional analysis and multi-system/discipline optimization. The community agent 214B allocates product performance parameters and monitors current product parameters. The community agent 214B compares current product performance parameters against performance objectives and analyzes trends and performance parameters and reports to other community agents 214A, 214C-214F. A requirements definition and management community agent 214C supports the definition and management of system or product requirements. The community agent 214C enforces constraints on parameters defined by an owner of the system or product and monitors parameters related to general product performance. The community agent 214C captures requirements and matches current and state parameters against constraints as defined by requirements definitions. Additionally, the community agent 214C also allocates parameter resources based on requirement priorities. A distributed computing community agent 214D supports the selection and use of computing resources available to service providers belonging to the project architectural framework 212. The community agent 214D allocates computing resources among the community represented by the project architectural framework 212 and monitors analysis applications and sequences of applications based on workflow. The community agent 214D selects or suggests (or both) the best available computing resources and requests or schedules (or both) computing resources. A workflow management agent 214E is a community agent that coordinates and controls processing. The community agent 214E represents the implementation of the business logic, rules, and conditions. The community agent 214E allocates time, information, and analysis resources. The community agent 214E also monitors activities according to defined or learned business logic, rules, constraints, and conditions. The community agent 214E compares current process parameters to those loaded or learned. Based on the status of current process parameters, the community agent 214E may invite additional or dismiss redundant resources or other functional or community agents. An application and model integration community agent 214F supports the integration of various applications and models for complex system engineering, optimization, and simulation. The community agent 214F allocates available and appropriate models as well as analysis/simulation applications. The community agent 214F monitors design process goals and product parameters. Additionally, the community agent 214F suggests, recommends, or both, available analysis and simulation applications. The community agent 214F also manages the rules associated with the application integration and manages the rules associated with the available models.

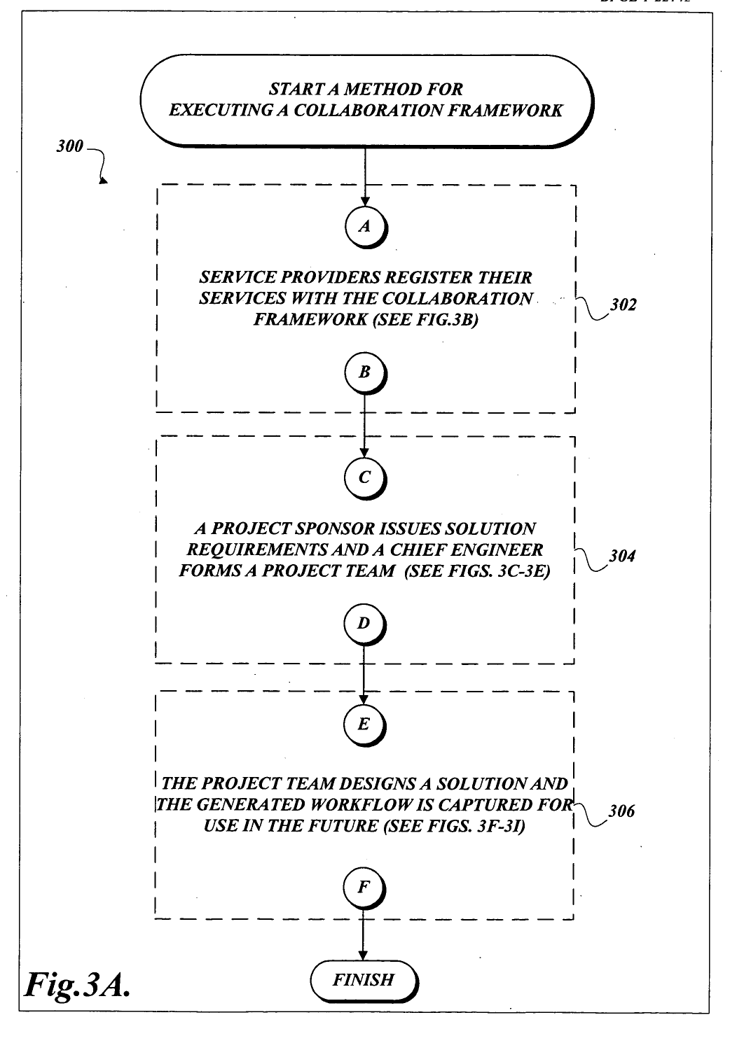

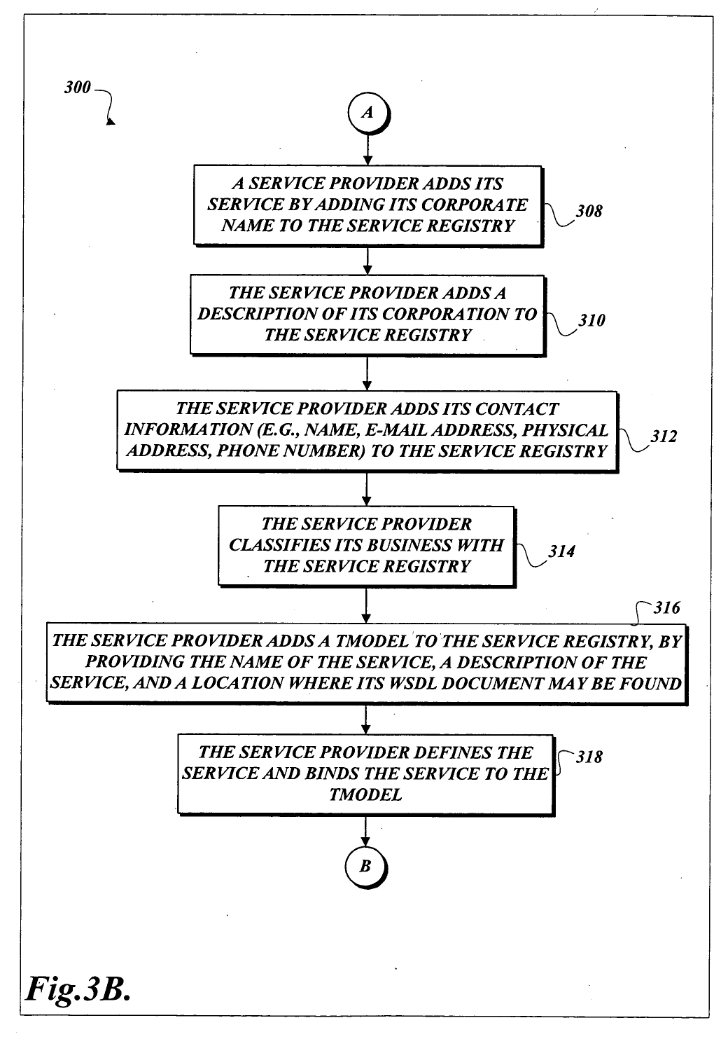

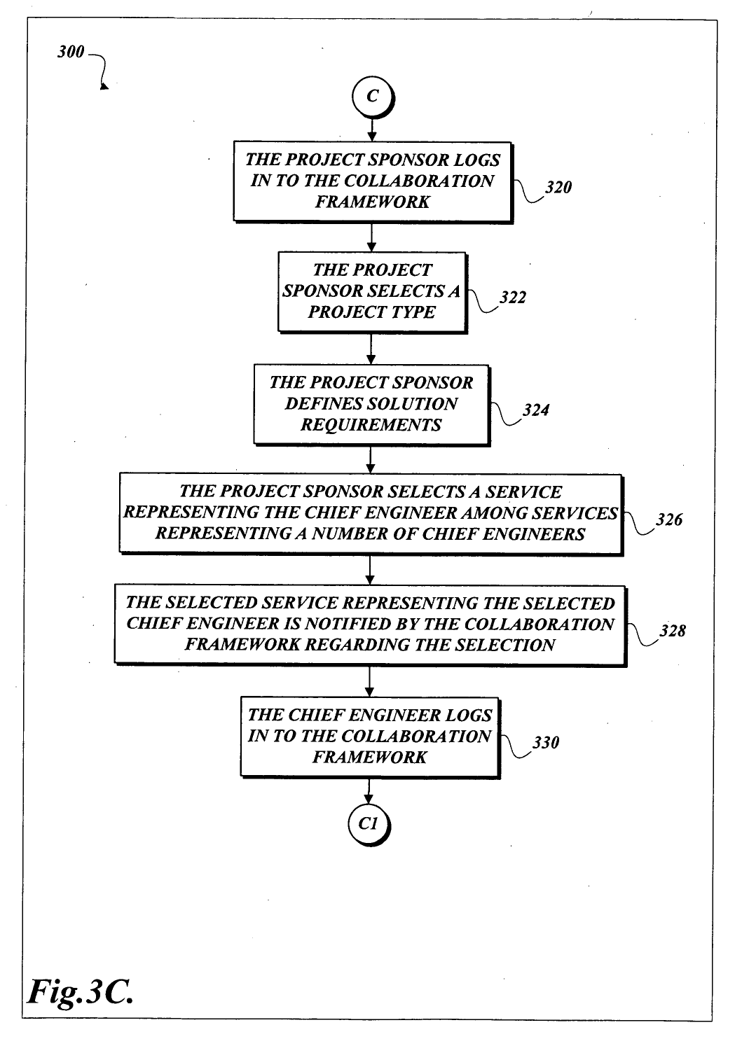

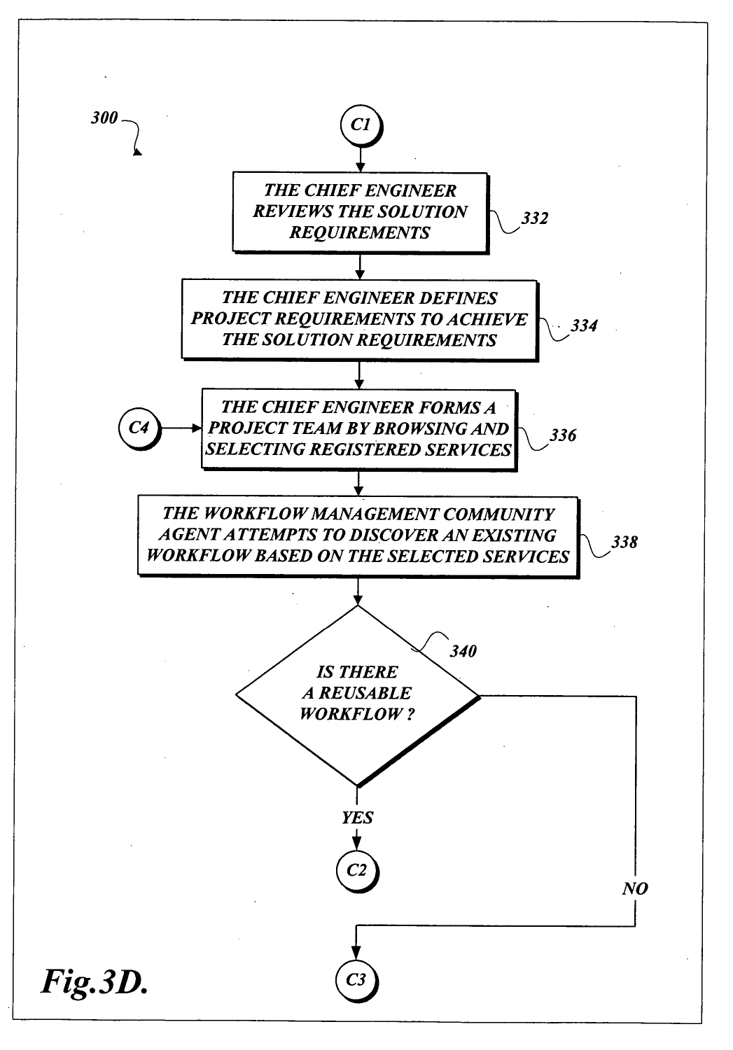

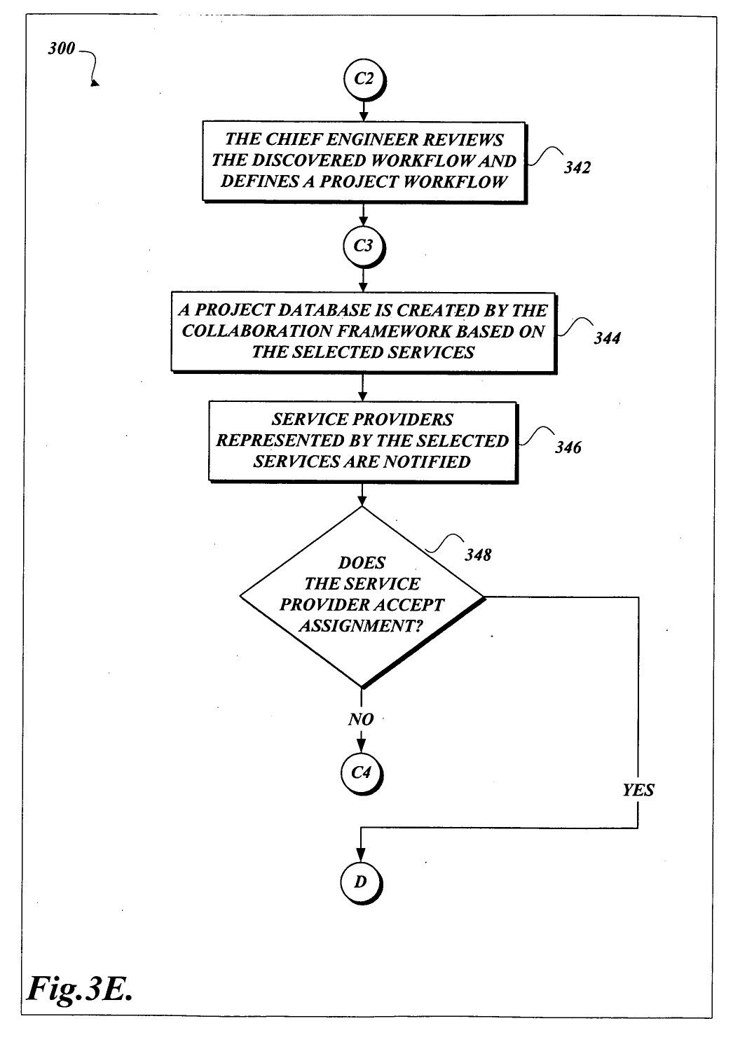

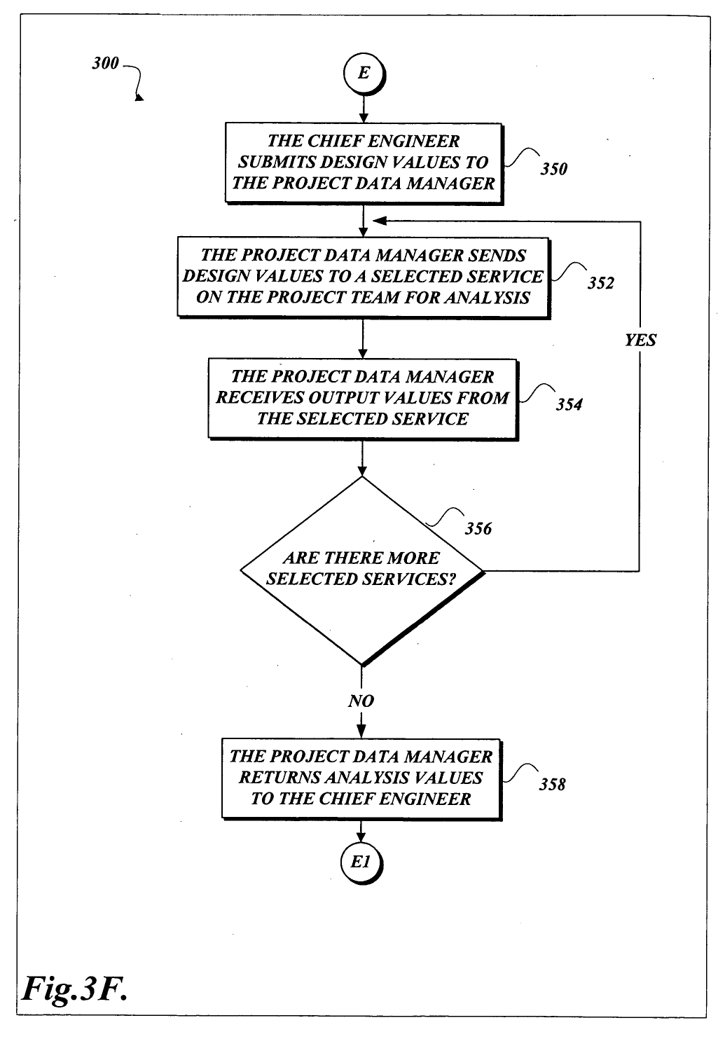

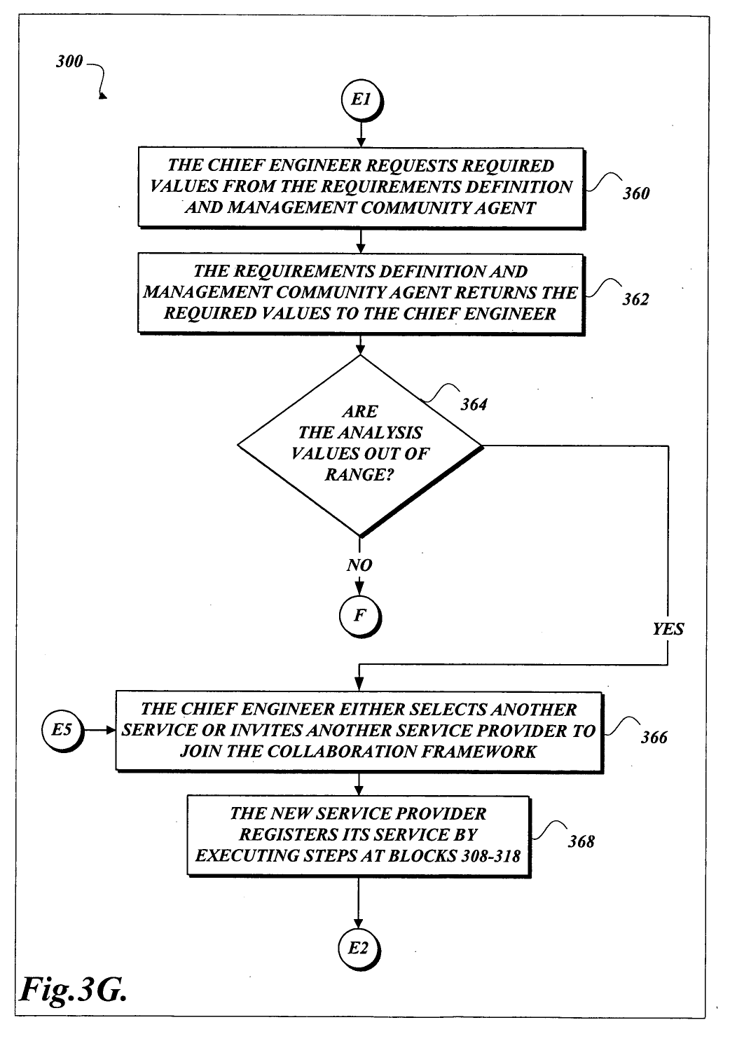

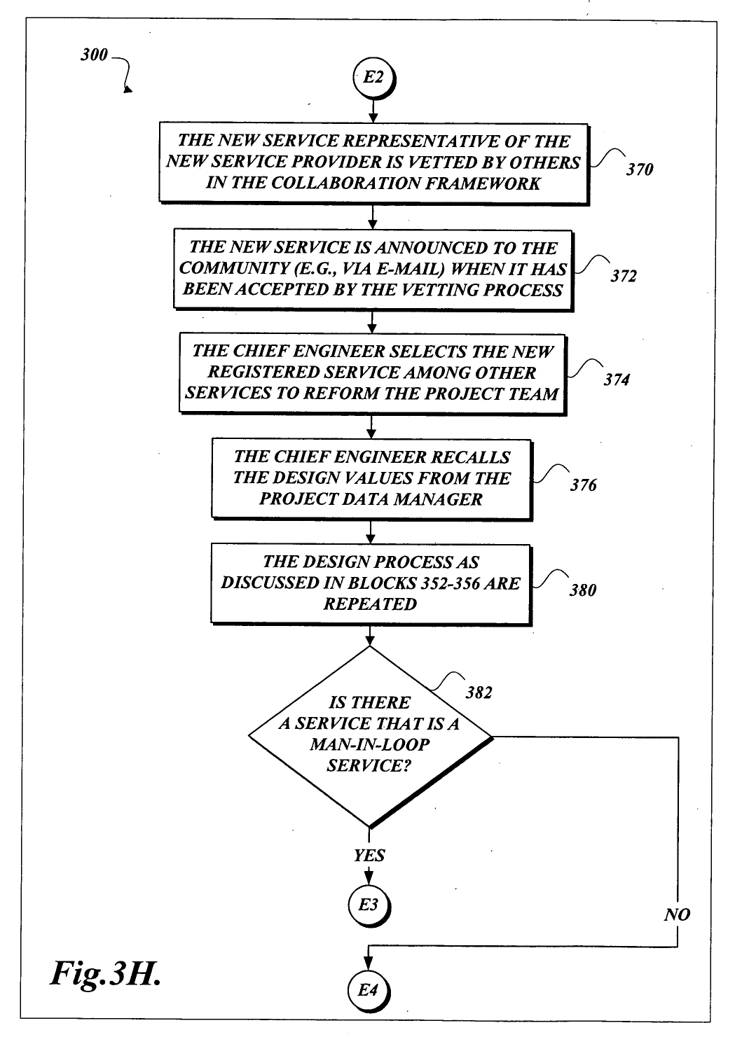

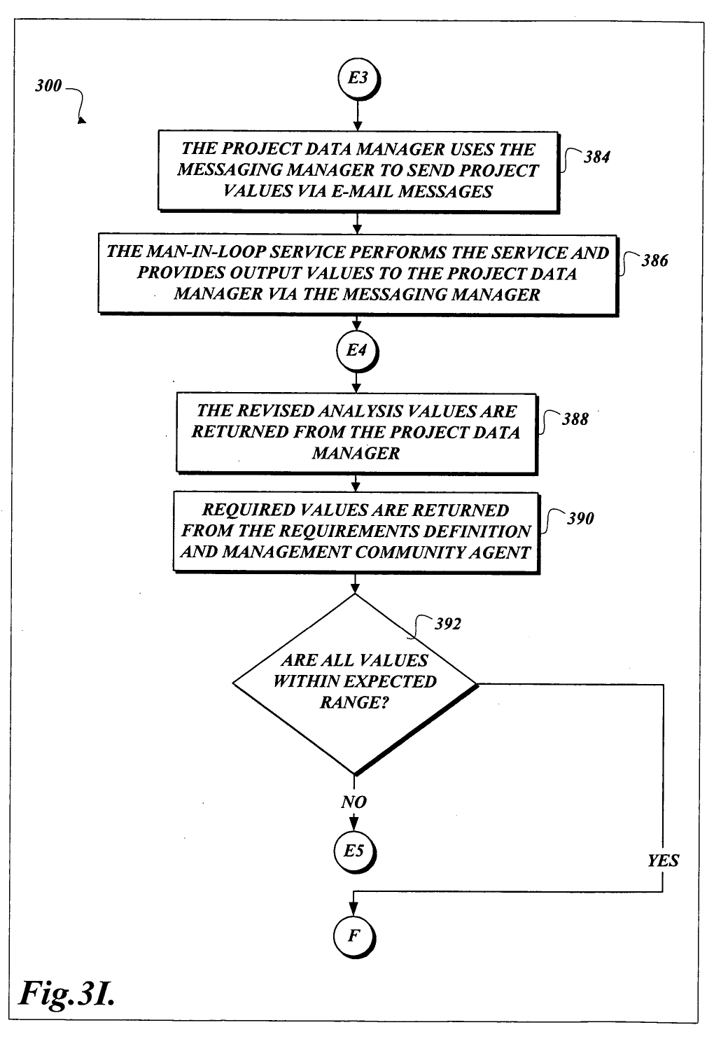

FIGS. 3A-3I illustrate a method 300 for executing the collaboration framework 212. For clarity purposes, the following description of the method 300 makes references to various elements illustrated in connection with the collaboration framework 212 shown in FIG. 2B; the service registry 216 shown in FIG. 2C; and the community agents 214 shown in FIG. 2G. From a start block, the method 300 proceeds to a set of method steps 302, defined between a continuation terminal (“terminal A”) and an exit terminal (“terminal B”). The set of method steps 302 describes the registration of services by service providers with the collaboration framework 212.

From terminal A (FIG. 3B), the method 300 proceeds to block 308 where a service provider adds its service by adding its corporate name to the service registry 216. Next, at block 310, the service provider adds a description of its corporation to the service registry 216. The service provider then adds its contact information, such as name, e-mail address, physical address, and phone number, to the service registry 216. See block 312. The method 300 proceeds to block 314 where the service provider classifies its business category with the service registry 216. At block 316, the service provider adds a tModel to the service registry 216 by providing the name of the service, a description of the service, and a location where its WSDL file may be found. (The service provider adds the necessary binding information, such as, the location of the relevant WSDL file and extending one or more tModel files' locations.) The service provider then defines the service and binds the service to the tModel. (In another embodiment, the service is bound to the WSDL file and the one or more tModel files. Alternatively there is enough information provided in the service registration process to allow for the WSDL file and one or more tModel files to be generated.) See block 318. Next, the method 300 proceeds to the exit terminal B.

From the exit terminal B (FIG. 3A), the method 300 proceeds to a set of method steps 304, defined between a continuation terminal (“terminal C”) and an exit terminal (“terminal D”). The set of method steps 304 describes the issuance of solution requirements by a project sponsor and the formation of a project team by a chief engineer.

From terminal C (FIG. 3C), the method 300 proceeds to block 320 where the project sponsor logs into the collaboration framework 212. Next, at block 322, the project sponsor selects a project type. The project sponsor then defines solution requirements. See block 324. The method 300 proceeds to block 326 where the project sponsor selects a service representing the chief engineer among services representing a number of chief engineers. Next, at block 328, the selected service representing the selected chief engineer is notified by the collaboration framework 212 regarding the selection. The chief engineer logs into the collaboration framework. See block 330. The method 300 then enters another continuation terminal (“terminal C1”).

From terminal Cl (FIG. 3D), the method 300 proceeds to block 332 where the chief engineer reviews the solution requirements. Next, at block 334, the chief engineer defines project requirements to achieve the solution requirements as specified by the project sponsor. The chief engineer forms a project team by browsing and selecting registered services using the service registry 216. See block 336. The workflow management community agent 214E attempts to discover an existing workflow based on the selected services. See block 338. The method 300 then proceeds to decision block 340 where a test is made to determine whether there is a reusable workflow. If the answer to the test at decision block 340 is YES, the method 300 enters another continuation terminal (“terminal C2”). Otherwise, the answer to the test at decision block 340 is NO, and another continuation terminal (“terminal C3”) is entered by the method 300.

From terminal C2 (FIG. 3E), the method 300 proceeds to block 342 where the chief engineer reviews the discovered workflow and defines a project workflow. From terminal C3 (FIG. 3E), the method 300 proceeds to block 344 where a project database is created by the collaboration framework 212 based on the selected services. Next, at block 346, the service providers, such as service providers 204-210 represented by the selected services, are notified. A test is made at decision block 348 to determine whether the service provider accepts the assignment. If the answer to the test at decision block 348 is NO, another continuation terminal (“terminal C4”) is entered by the method 300 to loop back to block 336 where the above-identified processing steps are repeated. Otherwise, the answer to the test at decision block 348 is YES, and the exit terminal D is entered by the method 300.

From the exit terminal D (FIG. 3A), the method 300 proceeds to a set of method steps 306, defined between a continuation terminal (“terminal E”) and an exit terminal (“terminal F”). The set of method steps 306 describes the design of a solution by the project team and the capturing of the generated work flow for work in the future.

From terminal E (FIG. 3F), the method 300 proceeds to block 350 where the chief engineer submits design values to the project data manager 220. Next, at block 352, the project data manager 220 sends design values to a selected service of the project team for analysis. The project data manager 220 then receives output values from the selected service. See block 354. The method 300 then proceeds to decision block 350 where a test is made to determine whether there are more selected services on the project team. If the answer to the test at decision block 356 is YES, the method 300 loops back to block 352 where the above-described processing steps are repeated. Otherwise, the answer to the test at decision block 356 is NO, the method 300 proceeds to block 358, where the project data manager 220 then proceeds to another continuation terminal (“terminal E1 ”).

From terminal E1 (FIG. 3G), the method 300 proceeds to block 360 where the chief engineer requests required values from the requirements definition in management community agent 214C. Next, at block 362, the requirements definition in management community agent 214C returns the required values to the chief engineer. A test is made at decision block 364 to determine whether the analysis values are out of range. If the answer to the test at decision block 364 is NO, the method 300 enters the exit terminal F and terminates execution. Otherwise, the answer to the test at decision block 364 is YES, and the method 300 proceeds to block 366 where the chief engineer either selects another service or invites another service provider to join the collaboration framework 212. Next, at block 368, the new service provider registers its service by executing steps at blocks 308-318 described above. The method 300 then enters another continuation terminal (“terminal E2”).

From terminal E2 (FIG. 3H), the method 300 proceeds to block 370 where the new service is vetted by others in the collaboration framework 212. (Here is one benefit where the verification, validation, and verification tModel helps as it standardizes and makes searchable the relevant vetting information and criteria.) Next, at block 372, the new service is announced to the community (e.g., via e-mail or other suitable methods) when it has been accepted by the vetting process. The chief engineer selects the new registered service among other services to reform the project team. See block 374. The chief engineer recalls the design values from the project data manager 220. See block 376. Next, at block 380, the design process is discussed in blocks 352-356 and is repeated as described above. The method 300 proceeds to decision block 382 where a test is made to determine whether there is a man-in-loop service. If the answer to the test at decision block 382 is YES, the method 300 proceeds to another continuation terminal (“terminal E3”). Otherwise, the answer to the test at decision block 382 is NO, and the method 300 proceeds to another continuation terminal (“terminal E4”).

From terminal E3 (FIG. 31), the project data manager 220 uses the messaging manager 224 to send project values via e-mail messages. See block 384. Next, at block 386, the man-in-loop service performs the service and provides output values to the project data manager 220 via the messaging manager 224. From terminal E4 (FIG. 31), the method 300 proceeds to block 388 where the revised analysis values are returned from the project data manager 220. Next, at block 390, the required values are returned from the requirements definition and management community agent 214C. See block 390. The method 300 then proceeds to decision block 392 where a test is made to determine whether all values are within the expected range. If the answer is NO, the method 300 proceeds to another continuation terminal (“terminal E5”) to loop back to block 366 where the above-described processing steps are repeated. Otherwise, the answer to the test at decision block 392 is YES, and the method 300 proceeds to the exit terminal F and terminates execution.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A networked system, comprising:
a set of Web services, each representing a member selected from a group consisting of a human service provider and a piece of software; and
a collaboration framework for allowing the set of Web services to work jointly together to solve an engineering problem, the collaboration framework including a universal description discovery and integration framework that has information pertaining to verification, validation, and accreditation of each Web service in the set of Web services.

2. The networked system of claim 1, wherein the set of Web services-includes a Web service that represents government laboratories.

3. The networked system of claim 1, wherein the set of Web services includes a Web service that represents academic institutions.

4. The networked system of claim 1, wherein the set of Web services includes a Web service that represents military departments.

5. The networked system of claim 1, wherein the set of Web services includes a Web service that represents businesses.

6. A system for allowing Web services to collaborate, comprising:
a set of Web services, each Web service being selected from a group consisting of a first service representing a piece of software that provides engineering analysis, a second service representing a human that provides engineering analysis, and a composed service; and
a service registry for allowing the set of Web services to be registered, the service registry being capable of allowing the registered Web services to be discovered.

7. The system of claim 6, further comprising a set of functional agents for coordinating Web services within an engineering discipline and a set of community agents for coordinating functional agents across engineering disciplines.

8. The system of claim 6, further comprising a project data manager for creating a project database, the project data manager being capable of returning values generated by Web services in the course of engineering analysis.

9. The system of claim 6, further comprising a workflow manager for capturing decisions, knowledge, and experiences of Web services as a workflow for a particular project.

10. The system of claim 6, further comprising a messaging manager for allowing services to be wrapped in a customizable, tag-based protocol for connecting into the system so as to collaborate with the set of Web services.

11. In a computing system, a set of collaborative software agents, comprising:
a set of functional agents for coordinating Web services within an engineering discipline; and
a set of community agents for coordinating functional agents across engineering disciplines, the set of community agents including an arrangement configuration design and analysis community agent, the set of community agents further including a requirements definition and management community agent.

12. The system of claim 11, the set of community agents further comprising a multi-disciplinary analysis and optimization community agent.

13. The system of claim 11, the set of community agents further comprising a distributed computing community agent.

14. The system of claim 11, the set of community agents further comprising a workflow management community agent.

15. The system of claim 11, the set of community agents further comprising an application and model integration community agent.

16. A computer-implemented method for executing a collaboration framework, comprising:
registering Web services by the service provider with the collaboration framework;
issuing solution requirements by a project sponsor Web service;
forming of a project team by a chief engineer Web service; and
capturing a workflow as the project team designs a solution to satisfy the solution requirements.

17. The computer-implemented method of claim 16, wherein forming the project team includes selecting desired Web services by the chief engineer Web service.

18. The computer-implemented method of claim 17, further comprising discovering a reusable workflow based on the selected Web services by the chief engineer Web service.

19. The computer-implemented method of claim 18, further comprising sending design values to the selected Web services for analysis of a solution.

20. The computer-implemented method of claim 19, wherein the act of sending design values includes sending design values by e-mail if a selected Web service represents a human service provider who provides the analysis.
